(19) United States
(12) Patent Application Publication
(10) Pub. No.: US 2006/0164387 A1
(43) Pub. Date: Jul. 27, 2006

(54) Input apparatus and touch-reading character/symbol input method

(75) Inventor: Kazuhiko Takisima, Yamanashi (JP)

Correspondence Address: DICKSTEIN SHAPIRO MORIN & OSHINSKY LLP, 1177 AVENUE OF THE AMERICAS (6TH AVENUE), 41 ST FL., NEW YORK, NY, 10036-2714, US

(73) Assignee: NEC Corporation

(21) Appl. No.: 11/337,510

(22) Filed: Jan. 24, 2006

(30) Foreign Application Priority Data
Jan. 26, 2005 (JP) 17655/2005

(51) Int. Cl. G09G 5/00

(52) U.S. Cl. 345/156

(57) ABSTRACT

An input apparatus including: a display screen which visually displays information; an input member which is made of a transparent member to allow at least part of beams to pass and placed in a region of space in front of the display screen and elastically displaces a specific region of the input member toward the display screen in response to an external force, where embosses are formed on a surface of the input member to represent characters or symbols; and a coordinate position detecting device which, being placed between the display screen and the specific region of the input member, detects a coordinate position of the displacement of the specific region on the display screen.

### BACKGROUND OF THE INVENTION

1. Field of the Invention

The present invention relates to an input apparatus having a mechanism for inputting various data using touch-reading characters/symbols such as braille characters and to a touch-reading character/symbol input method. More particularly, the present invention relates to an input apparatus which has a coordinate position detecting device such as a touch panel and a touch-reading character/symbol-based input mechanism mounted on the front of a display screen as well as to a touch-reading character/symbol input method.

2. Description of the Related Art

Input apparatus using a touch panel not only allow intuitive operations according to touched locations on a screen, but also allow coordinates or positions to be inputted without using a pointing device such as a mouse. Thus, they are used for portable terminals such as PDAs (Personal digital Assistants), cash dispensers, ticket vending machines at stations, and various information processors, combining input and display apparatus. Also, since they allow positions of curves and points to be inputted freely, they are used as tablets for graphics software or CAD (Computer Aided Design) software.

Conventionally, touch panels consist of pressure sensors arranged in such away as to cover a display surface of a display apparatus. Recently, touch panels have appeared which recognize coordinates of touched locations on a screen by sending out ultrasonic waves into a region of space located in front of the display screen, by outputting beams in a matrix, or by capturing images in front of the display screen.

Incidentally, input apparatus using a touch panel are inseparably related to a position from which inputs are entered or with respect to which coordinates are defined. Therefore, touch panels linked to a display apparatus which needs visual confirmation are difficult to use for people with visual disabilities (hereinafter referred to as visually impaired people). To deal with this problem, for example, Japanese Patent Laid-Open No. 2002-49461 (Paragraph 0019, Paragraph 0020, and FIG. 1) (hereinafter referred to as Patent Document 1) discloses an arrangement in which a braille sheet containing combinations of embossed semispherical dots serving as touch-reading braille characters is placed over a keyboard panel unrelated to a display apparatus.

Patent Document 1 makes a proposal to place the braille sheet containing embossed braille patterns over a surface of the keyboard panel, which is a dedicated input apparatus. That is, this input apparatus provides braille embosses on the dedicated keyboard panel instead of displaying a keyboard on the display screen itself which displays various information, allowing keys to be selected using a touch panel. Thus, the display screen such as a CRT (Cathode Ray Tube) must be installed separately from the keyboard panel. This makes it difficult for PDAs and similar information processors with limited space to adopt the proposal disclosed in Patent Document 1 as well as to perform intuitive operations on the display screen.

To deal with this problem, for example, Japanese Patent Laid-Open No. 7-319623 (Paragraph 0018 and FIG. 2) (hereinafter referred to as Patent Document 2) discloses an arrangement in which an embossed sheet is affixed on a touch panel placed directly on the display screen. Patent Document 2 makes a proposal to place a touch panel on a liquid crystal panel serving as a dedicated control panel used to adjust screen density. Transparent sheets are affixed on those locations on the surface of the touch panel which are to be touched, where appropriate touch-reading characters/symbols such as marks or braille characters are embossed on the transparent sheets. This allows visually impaired people to find a desired key position by groping for an appropriate touch-reading character/symbol on the touch panel and enter a desired input by pressing a finger against the touch panel at the key position.

As described earlier, there are not only pressure type touch panels, but also touch panels designed to input coordinates by sensing an object such as a finger existing in front of the display screen. Even if a user accidentally touches an irrelevant key only lightly when seeking for a desired key, such an optical or ultrasonic touch panel detects the touched key.

On the other hand, the pressure type touch panel does not detect a key touched only lightly. However, a level of pressure exerted when a visually impaired person traces embosses to seek for a touch-reading character/symbol can result in a false detection of a key.

In the case of the input apparatus according to the second proposal, if a weak-sighted person brings his/her face very close to the touch panel to recognize displayed characters, his/her nose or part of glasses may enter an optical or ultrasonic sensing range or is captured as part of an optical image. Then, a key press may be detected and there is a high risk that an unintended key input is accepted inadvertently.

Unlike the proposal of Patent Document 2 according to which sheets are affixed on the touch panel provided on the display screen, Japanese Patent Laid-Open No. 1-13868 (Paragraph 0027 and FIG. 1) (hereinafter referred to as Patent Document 3), for example, makes a proposal to provide embosses on the surface of a touch panel itself. The proposal of Patent Document 3 have similar problems to the proposal of Patent Document 2. To deal with these problems, Japanese Patent Laid-Open No. 2004-265035 (Paragraph 0018 and FIG. 2) (hereinafter referred to as Patent Document 4) discloses an input apparatus designed such that a touch panel will not cause a false detection when embosses such as braille characters are read by hand.

FIG. 7 is a diagram showing the essence of the input apparatus disclosed in Patent Document 4. A display screen 102 enclosed by an outer frame 101 is equipped with an input section 103a. It composes a touch panel 103 in conjunction with the input section 103a. As an example, an Confirm button 104 for use to confirm processes is shown on the display screen 102. When the user presses the Confirm button 104 by a finger or the like, the input section 103a detects the press and inputs Confirm. The above procedures are intended for people other than visually impaired people.

According to the proposal of Patent Document 4, for visually impaired people, a press-down member 105 is attached to the outer frame 101 near the Confirm button 104 and slightly above the surface of the display screen 102. Embossed braille characters 106 are provided on the press-down member 105 to identify the Confirm button. Touch-reading characters/symbols representing characters, symbols, or graphics to be recognized by touch maybe embossed on the surface instead of the embossed braille characters 106. However, this specification will focus on braille characters as an example of touch-reading characters/symbols for ease of explanation.

FIG. 8 is a sectional view of the press-down member and its surroundings taken along line A-A in FIG. 7. The press-down member 105 includes a push pad 105a extending horizontally from the upper end of the outer frame 101 and a projection 105b protruding from the tip of the push pad 105a toward the display screen 102. The press-down member 105 is made of an opaque resilient resin. Semispherical embosses 106 which represent braille characters are formed on the push pad 105a.

With the input apparatus according to the proposal of Patent Document 4, when the push pad 105a is not pressed, the input section 103a is free from contact with the projection 105b. When the touch panel 103 is free from contact, it recognizes that the push pad 105a is not pressed. When the user presses the push pad 105a to enter Confirm, the push pad 105a bends downward due to its resiliency. Consequently, the projection 105b is lowered, coming into direct contact with the input section 103a, which in turn causes the touch panel 103 to detect that the push pad 105a is pressed. This allows even visually impaired people to operate Confirm and other buttons as required. The input apparatus, which can be operated without touching the touch panel 103 directly, may be easier to operate even for senior citizens who often find it difficult to operate input apparatus.

According to the technique disclosed in Patent Document 4, since the press-down member 105 embossed with marks such as braille characters is placed away from the touch panel, the touch panel does not detect position yet at the time when the embossed marks are touched by fingers. However, with the input apparatus according to the patent document, the press-down member 105 protrudes over a display area of the display screen. Thus, that part of the display area which is directly under the protruding member is obscured from view and is not used for display.

### SUMMARY OF THE INVENTION

An exemplary feature of the present invention is to provide an input apparatus and touch-reading character/symbol input method which allows effective use of that part of a display area which is covered by a member which, hanging over the display area, brings a coordinate position detecting device such as a touch panel into operation.

To solve the exemplary and other problems above, an input apparatus according the present invention is an input apparatus including: a display screen which visually displays information; an input member which is made of a transparent member to allow at least part of beams to pass and placed in a region of space in front of the display screen and elastically displaces a specific region of the input member toward the display screen in response to an external force, where embosses are formed on a surface of the input member to represent characters or symbols; and a coordinate position detecting device which, being placed between the display screen and the specific region of the input member, detects a coordinate position of the displacement of the specific region on the display screen.

An exemplary advantage of the present invention is to provide an input apparatus and touch-reading character/symbol input method which allows effective use of that part of a display area which is covered by a member which, hanging over the display area, brings a coordinate position detecting device such as a touch panel into operation. This is made possible because an input member placed in front of a display screen and used to input characters, symbols, and the like is a transparent member which allows at least part of beams to pass.

### BRIEF DESCRIPTION OF THE DRAWINGS

The novel features believed characteristic of the invention are set forth in the appended claims. The invention itself, however, as well as other features and advantages thereof, will be best understood by reference to the detailed description which follows, read in conjunction with the accompanying drawings, wherein:

FIG. 1 is a plan view showing the essence of an input apparatus according to an embodiment of the present invention;

FIG. 2 is a sectional view of the essence of a push button and its surroundings taken along line B-B in FIG. 1;

FIG. 3 is an explanatory diagram illustrating the principle of detecting presses of two push buttons placed along an X axis according to this embodiment;

FIG. 4 is a block diagram showing the essence of a circuit which performs display made change control according to this embodiment;

FIG. 5 is a flowchart showing how the input apparatus performs control when photoreceivers sense the absence of beams, according to this embodiment;

FIG. 6 is a sectional view of the essence of a push button and its surroundings according to a first variation of the present invention;

FIG. 7 is a plan view showing the essence of an input apparatus according to a technique disclosed in Patent Document 4;

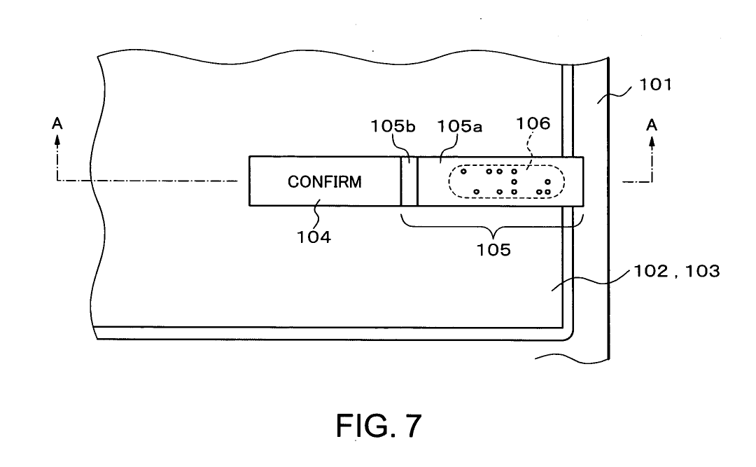

FIG. 8 is a sectional view of a press-down member and its vicinity taken along line A-A in FIG. 7; and

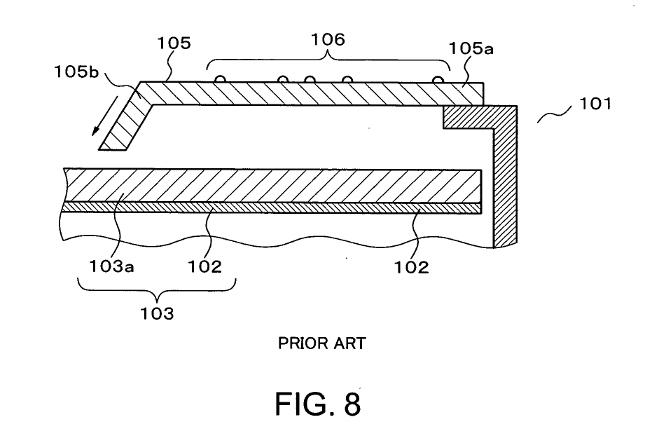

FIG. 9 is a sectional view of the essence of a push button and its surroundings according to a second variation of the present invention.

### DESCRIPTION OF THE EXEMPLARY EMBODIMENTS

The present invention will be described in detail below with reference to an exemplary embodiment.

### Exemplary Embodiment

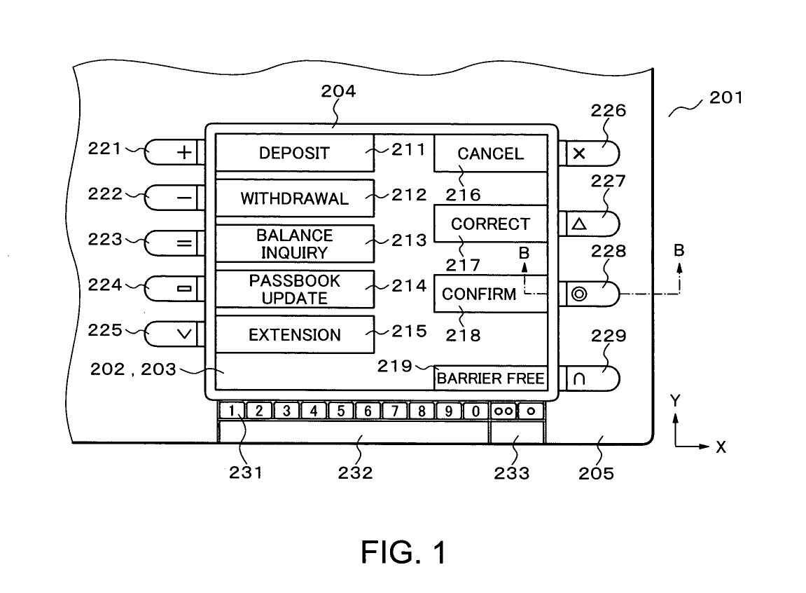

FIG. 1 is a diagram showing the essence of an input apparatus according to an embodiment of the present invention. The input apparatus 201 according to this embodiment is used for a cash dispenser. The figure shows part of a display screen 202 mounted on top of the device. The display screen 202 is, for example, a display surface of a CRT placed face-up. A holding member 205 made of a transparent resin is placed over the display screen 202, surrounding a frame 204 which in turn surrounds a rectangular opening 203 provided in the center.

The display screen 202 is exposed inside the frame 204. A Deposit button 211, Withdrawal button 212, Balance Inquiry button 213, Passbook Update button 214, and Extension button 215 are provided in a display area in the left part of the exposed display screen 202 to implement functions of the cash dispenser according to this embodiment.

Also, a Cancel button 216, Correct button 217, Confirm button 218, and Barrier Free button 219 are provided in a display area in the right part. The Barrier Free button 219 is provided for visually impaired people. Selecting this button increases the size or weight of characters displayed on the display screen 202. When the user touches any of the buttons 211 to 219, the function represented by the button is enabled by a known touch-panel mechanism.

On the holding member 205, push buttons 221 to 229 movable in the direction perpendicular to the plane of the paper are installed near the respective buttons 211 to 219 displayed on the display screen 202. In addition to embossed marks which represent the functions of the push buttons, braille characters are embossed as semispherical marks (not shown) on the surface of the push buttons 221 to 229.

The buttons 211 to 219 have the same logical functions as the corresponding push buttons 221 to 229, and either one in each pair produces the same effect when pressed.

On the holding member 205 in front of that part of the display screen where the Barrier Free button 219 is displayed, a numeric push button group 231 consisting of numerals “1” to “0” and symbols which represent “10,000 yen” and “1,000” yen (“◯◯” and “◯” in FIG. 1) is arranged in a line along the frame 204. Braille-embossed keys 232 and 233 for numeric input are installed adjacent to the numeric push button group 231 on the holding member 205.

According to this embodiment, the holding member 205 is made of a transparent resin, and so are the push buttons 221 to 229 and numeric push button group 231. Alternatively, they may be made of transparent glass. However, they do not need to be so transparent that the display screen 202 under them will be optically visible without distortion. For example, except the locations of the push buttons 221 to 229 and numeric push button group 231 on the holding member 205 and locations of the braille-embossed keys 232 and 233, the resin surface may be finely textured so that only the brightness and color of appropriate locations on the display screen 202 will be visible. Also, the holding member 205 may be translucent or colored as long as it passes at least part of visible light.

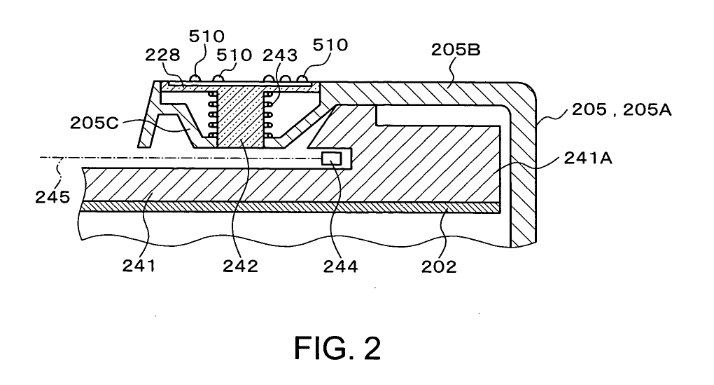

FIG. 2 shows a sectional structure of a push button and its surroundings taken along line B-B in FIG. 1. Although only the push button 228 is shown here, basically this also applies to the other push buttons 221 to 227 and 229 as well as individual push buttons in the numeric push button group 231. Thus, only the push button 228 will be described, and sectional illustration and description of the push buttons 221 to 227 and 229 as well as the individual push buttons in the numeric push button group 231 will be omitted.

Referring to FIG. 2, the surface of the display screen 202 is covered with a transparent protective sheet 241 whose edges are raised to constitute a detection mechanism 241A. The holding member 205 has a button holder 205B which is bent almost horizontally from a side wall 205A installed almost vertically.

The button holder 205B has a dish-shaped depression near its tip to constitute a button housing 205C. The button holder 205B has a circular opening 242 in the bottom. A stem of the push button 228 has its lower part loosely fitted in the opening 242 in a vertically movable manner, where the stem is T-shaped in cross section and has a plate attached to the top. Semispherical embosses 510 are formed as braille characters on the top face of the push button 228.

The lower part of the stem has its cylindrical external surface covered with a thin metallic coating. Alternatively, the external surface is finely textured or meshed to scatter light. A spring 243 formed by winding a transparent resin spirally is placed around the stem between the plate of the push button 228 and bottom of the button housing 205C.

When the push button 228 is not pressed by the user, the lower end of the stem of the push button 228 remains within the opening 242 or protrudes only slightly from the opening 242 by the force of the spring 243. When the push button 228 is pressed, the spring 243 is compressed in the vertical direction, causing the stem of the push button 228 to protrude downward from the opening 242 greatly and come close to the surface of the protective sheet 241.

A photoreceiver 244 is mounted on the detection mechanism 241A of the protective sheet. The photoreceiver 244 receives a beam 245 traveling along and slightly above the surface of the protective sheet 241. Thus, in normal state in which the push button 228 is not pressed, the photoreceiver 244 detects the beam 245. When the push button 228 is pressed, the photoreceiver 244 stops detecting.

Actually, in addition to the beam 245 shown in FIG. 2, multiple beams are outputted along an X axis at intervals along a Y axis orthogonal to the X axis along which the numeric push button group 231 shown in FIG. 1 are arranged. Also, multiple beams are outputted along the Y axis at intervals along the X axis. By detecting presence or absence of multiple beams outputted in a matrix with respective photoreceivers, it is possible to detect which push button is pressed. Incidentally, it is not strictly necessary that the X axis and Y axis should be orthogonal to each other, and they may intersect each other at a predetermined angle.

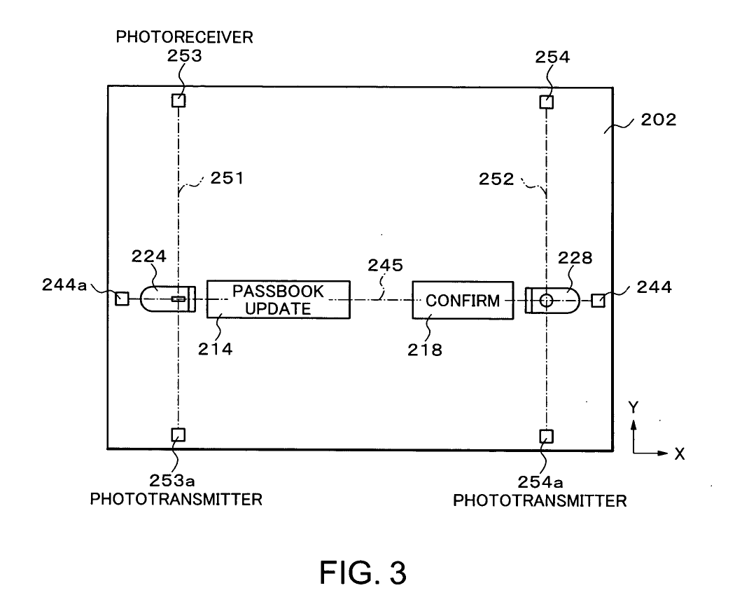

FIG. 3 illustrates the principle of detecting presses of two push buttons placed along the X axis, as an example. The push button 224 corresponding to the Passbook Update button 214 and push button 228 corresponding to the Confirm button 218 are placed at the same Y coordinate. Thus, when either of the push buttons 224 and 228 is pressed, the beam 245 is blocked and the photoreceiver 244 shown in FIG. 2 detects the press of the button.

Looking at two beams 251 and 252 along the Y axis corresponding to the two push buttons 228 and 224, respectively, when the push button 228 is pressed, the beam 251 is blocked. Consequently, the corresponding photoreceiver 253 fails to detect the beam 251. At this time, the photoreceiver 254 corresponding to the beam 252 continues to detect the beam 252.

That is, when looking at a specific push button, it can be determined that the push button is not pressed if at least one of the photoreceivers is activated: the photoreceiver which detects the beam passing through the push button along the X axis and the photoreceiver which detects the beam passing through the push button along the Y axis. On the other hand, it can be determined that the push button is pressed if neither of the photoreceivers is activated: the photoreceiver which detects the beam passing through the push button along the X axis and the photoreceiver which detects the beam passing through the push button along the Y axis.

In this way, by putting together detection/non-detection information from, the photoreceiver 244 which detects a beam along the X axis and detection/non-detection information from the photoreceivers 253 and 254 which detect beams along the Y axis, it is possible to detect whether the two push buttons 224 and 228 are pressed. This is also true to the other push buttons 221 to 223, 225, 226, 227, and 229 and the numeric push button group 231 shown in FIG. 1. Incidentally, phototransmitters 253a, 254a, and 244a placed opposite the photoreceiver 244 as light sources shown in FIG. 3 may be provided using actual emitting sources such as light-emitting diodes or using light emitted from the display screen 202 and reflected toward the photoreceivers by an optical system such as mirrors.

To allow the user to verify which of the push buttons 221 to 229 and numeric push button group 231 is pressed, the input apparatus 201 according to this embodiment performs display mode change control which involves inverting the color of that region of the display screen 202 which is pressed. This will be described below.

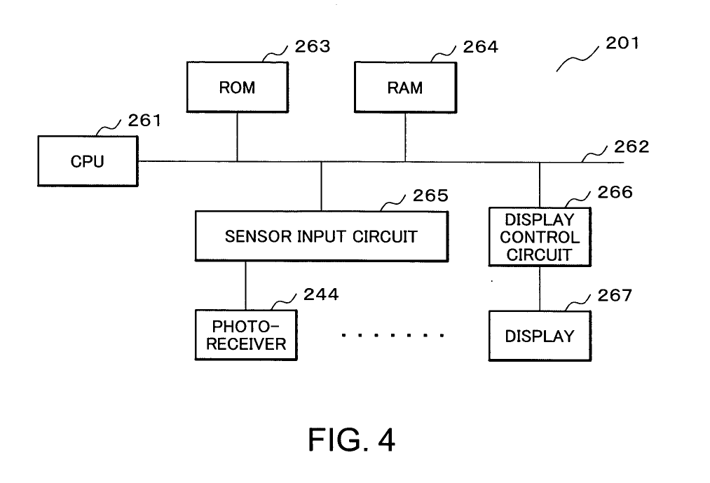

FIG. 4 shows the essence of a circuit which performs display mode change control according to this embodiment. The input apparatus 201 is equipped with a CPU 261, which is connected with various parts of the input apparatus 201 via a bus 262 such as a data bus. Among them, a ROM (Read Only Memory) 263 is a storage medium which stores a control program. A RAM (Random Access Memory) 264 temporarily stores various data needed by the CPU 261 when executing the control program.

A sensor input circuit 265 receives information as to whether or not a beam is detected by the photoreceiver 244 for the push button 228 shown in FIG. 2 or other photoreceivers for the push buttons 221 to 229 and numeric push button group 231. A display control circuit 266 controls a display 267 equipped with the display screen 202 shown in FIG. 1.

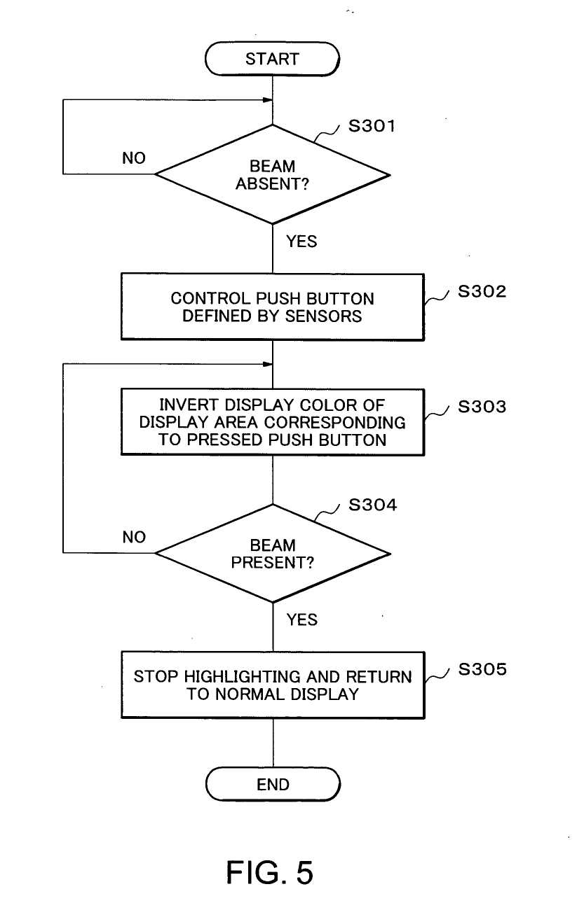

FIG. 5 shows how the input apparatus performs control when photoreceivers sense the absence of beams. The control is performed as the control program stored in the ROM 263 is executed by the CPU 261. That is, via the sensor input circuit 265, the CPU 261 monitors whether the photoreceiver 244 or other photoreceiver detects blocking (absence) of a beam (Step S301). If any of the photoreceivers detects the absence of a beam (Step S301: YES), the CPU 261 determines the push button at the coordinate position defined by a combination of photoreceivers which detect the absence of a beam as described with reference to FIG. 3 and performs control according to the pressed push button (Step S302). Then, by controlling the display control circuit 266, the CPU 261 inverts the display color of that part of the display screen 202 which corresponds to the pressed push button (Step S303). In so doing, if black characters are displayed on a white background, the display may be inverted to white-on-black. Alternatively, a red background may be inverted to a green background.

If the areas corresponding to the push buttons 221 to 229 and numeric push button group 231 are registered in the ROM 263 beforehand, only the area corresponding to the pressed push button can be inverted. Of course, the area may be highlighted in a usual manner by simple luminance changes or blinking.

The highlighting of the area on the display screen 202 corresponding to the pressed push button continues until the corresponding photoreceiver is activated by detecting a beam again (Steps S304 and S303). The Confirm button 218 corresponding to the push button 228 may also be highlighted. Highlighting may be continued for a certain period even when a push button is pressed only for a short time.

When the photoreceiver is activated by detecting a beam again (Step S304: YES), the CPU 261 stops highlighting, returns to normal display (Step S305), and ends the process.

As described above, according to the present invention the input member placed in front of the display screen and used to input characters, symbols, and the like is a transparent member which allows at least part of beams to pass.

Conventionally, part corresponding to relevant areas of a display screen is opaque and thus visual information from that part cannot be used. However, the present invention, according to which the corresponding part is transparent or translucent, can use the display area effectively.

Consequently, the present invention makes it possible, for example, to invert images or change colors in the corresponding areas of the display screen, allowing intuitive operations. That is, the present invention cannot only detect an appropriate coordinate position on the display screen when the input member is elastically deformed, but also change display mode of the corresponding part of the display screen accordingly and thereby highlight the area corresponding to the push button manipulated by the user.

This allows visually impaired people such as weak-sighted people who cannot recognize individual characters and symbols to verify the push button they press as long as they can recognize changes in light or color. This also allows people other than visually impaired people to more easily verify the push button they press. Consequently, even people such as senior citizens who are not familiar with the operation of apparatus can carry out input operations more reliably. Also, those areas of the display screen 202 which are conventionally not used for display can be used effectively.

### First Variation of the Invention

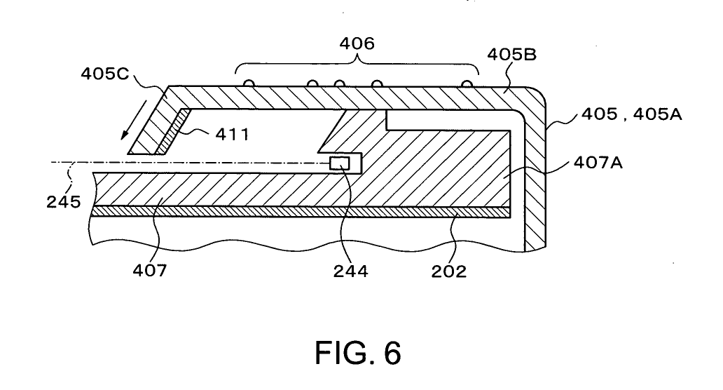

FIG. 6 shows a sectional structure of a push button and its surroundings according to a first variation of the present invention. In FIG. 6, the same components as those in FIG. 2 are denoted by the same reference numerals as the corresponding components, and description thereof will be omitted where appropriate. In the input apparatus according to the first variation, a press-down member 405 includes a support 405A perpendicular to the display screen 202, a flat push pad 405B which extends horizontally from the upper end of the support 405A, and a visor 405C which bends toward the display screen 202 from the tip of the push pad 405B. The press-down member 405 is made of transparent resilient resin.

Embossed braille characters 406 are formed on the top face of the push pad 405B. The surface of the display screen 202 is covered with a transparent protective sheet 407 whose edges are raised to constitute a detection mechanism 407A. A photoreceiver 244 is mounted in the detection mechanism 407A. The photoreceiver 244 receives a beam 245 traveling along and slightly above the surface of the protective sheet 407.

The visor 405C of the press-down member 405 is made of a transparent material and passes beams if nothing is done. Therefore, opaque shading tape 411 is bonded to an inner surface of the visor 405C to cut off the beam 245. A substance which cuts off or reflects light may be applied to the visor 405C instead of using the shading tape 411. Alternatively, the visor 405C itself may be made of a shading material.

Since the press-down member 405 is configured as described above, when a visually impaired person or other user presses the push pad 405B, the shading tape 411 on the visor 405C blocks the beam 245. Consequently, the photoreceiver 244 switches from ON (detection) to OFF (non-detection).

Since the press-down member 405 is transparent except for the visor 405C, by changing the color or brightness of the corresponding area of the display screen 202 according to detection or non-detection by the photoreceiver 244, it is possible to let the user know that the corresponding button is pressed. Of course, in this variation again, if the user touches the Confirm button or the like located in an area adjacent to the given push button on the display screen 202, the display in the screen area adjacent to the touched button changes as is the case with the above embodiment. Thus, the present invention makes it possible to implement a user friendly input apparatus by using the display screen 202 effectively.

The first variation offers the same advantages as the embodiment described earlier. In addition, it has the following advantages.

Specifically, according to the first variation, the press-down member 405 does not incorporate a push button such as the one provided in the embodiment. This makes it possible not only to reduce the cost of the entire input apparatus, but also to configure the push pad 405B as a transparent plate except for the embossed braille characters 406 on the push pad 405B. Thus, that area of the display screen 202 which is located directly under the press-down member 405 can be used to display characters and images as information for the user. That is, it is possible to make effective use of that part of the display screen 202 which is located outside the frame 204 shown in FIG. 1.

### Second Variation of the Invention

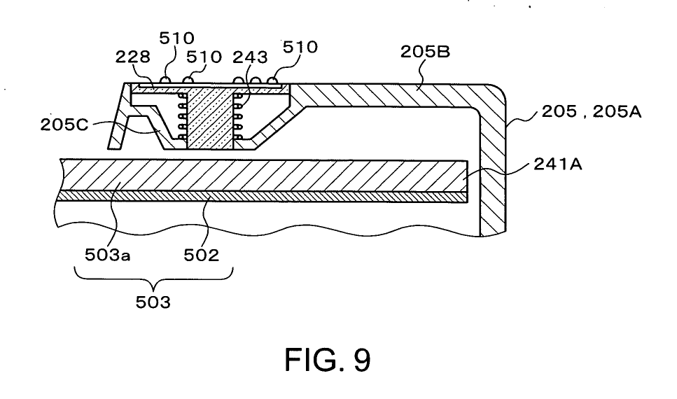

FIG. 9 shows a sectional structure of a push button and its surroundings according to a second variation of the present invention. In FIG. 9, the same components as those in FIG. 2 are denoted by the same reference numerals as the corresponding components, and description thereof will be omitted where appropriate. The configuration shown in FIG. 1 also applies to this variation, and description thereof will be omitted.

Although only the push button 228 is shown here, basically this also applies to the other push buttons 221 to 227 and 229 as well as individual push buttons in the numeric push button group 231. Thus, only the push button 228 will be described, and sectional illustration and description of the push buttons 221 to 227 and 229 as well as the individual push buttons in the numeric push button group 231 will be omitted.

A display screen 502 shown in FIG. 9 is equipped with an input section 503a. It composes a touch panel 503 in conjunction with the input section 503a. The touch panel 503 combines a display function implemented by the display screen 502 and a touch input function which performs an input process as the input section 503a is touched by hand.

As an example, an Confirm button 218 for use to confirm processes is shown on the display screen 502. When the user presses the Confirm button 218 by a finger or the like, the input section 503a detects the location where the input section is pushed the press and inputs Confirm. The above procedures are intended for people other than visually impaired people.

The holding member 205 has a button holder 205B which is bent almost horizontally from a side wall 205A installed almost vertically. The button holder 205B has a dish-shaped depression near its tip to constitute a button housing 205C. The button holder 205B has a circular opening 242 in the bottom. A stem of the push button 228 has its lower part loosely fitted in the opening 242 in a vertically movable manner, where the stem is T-shaped in cross section and has a plate attached to the top. Semispherical embosses 510 are formed as braille characters on the top face of the push button 228.

The lower part of the stem has its cylindrical external surface covered with a thin metallic coating. Alternatively, the external surface is finely textured or meshed to scatter light. A spring 243 formed by winding a transparent resin spirally is placed around the stem between the plate of the push button 228 and bottom of the button housing 205C.

When the push button 228 is not pressed by the user, the lower end of the stem of the push button 228 remains within the opening 242 or protrudes only slightly from the opening 242 by the force of the spring 243. The input section 503a is free from contact with the stem of the push button 228. When the push button 228 is pressed, the spring 243 is compressed in the vertical direction, causing the stem of the push button 228 to protrude downward from the opening 242 greatly and come into direct contact with the input section 503a of the touch panel 503.

As the tip of the stem of the push button 228 comes into direct contact with the input section 503a, the touch panel 503 detects that the push button 228 is pressed. This allows even visually impaired people to operate Confirm and other buttons as required.

The second variation can offer the same advantage as the embodiment.

### Other Variations of the Invention

According to the first variation described above, the push pad 405B is a flat transparent member, but this is not restrictive. For example, appropriate part of the push pad 405B and other areas which pass light may be configured to form a convex lens when the push pad 405B or display screen 202 is viewed by the user from the opposite direction, in order to magnify characters and other information displayed in the corresponding areas of the display screen 202 so that even weak-sighted people can make them out. Alternatively, fine slits, a mesh pattern, or a satin finish may be provided on the front or back side of all or specific areas of the holding member 205 to diffuse screen colors and thereby provide a clear display with the colors of individual regions leveled out.

Although in the embodiment, first variation, and second variation described above, the present invention is applied to a cash dispenser, naturally the present invention is also applicable to various input apparatus which use a touch panel. The touch panel is not limited to the type which emits beams at intervals in the X and Y directions as described in the embodiment and thereby detects an object such as a finger, for example, a few millimeters above the surface of a specific region. For example, images of an object such as a finger which touches a display screen may be picked up by a TV camera and the touched location may be detected by analyzing the images. A known technique which uses ultrasonic waves for similar position detection may also be adopted. Of course, the pressing position of an object such as a finger may be detected as is conventionally the case.

The configurations described above may be used in combination without departing from the spirit and the scope of the present invention.

While this invention has been described with reference to illustrative exemplary embodiments, this description is not intended to be construed in a limiting sense. Various modifications of the illustrative embodiments as well as other embodiments of the invention will be apparent to persons skilled in the art upon reference to this description. It is, therefore, contemplated that the appended claims will cover any such modifications or embodiments as fall within the true scope of the invention.

Further, it is the inventor's intent to retain all equivalents of the claimed invention even if the claims are mended during prosecution.

What is claimed is:

1. An input apparatus comprising:
a display screen which visually displays information;
an input member which is made of a transparent member to allow at least part of beams to pass and placed in a region of space in front of the display screen and elastically displaces a specific region of the input member toward the display screen in response to an external force, where embosses are formed on a surface of the input member to represent characters or symbols; and
a coordinate position detecting device which, being placed between the display screen and the specific region of the input member, detects a coordinate position of the displacement of the specific region on the display screen.

2. The input apparatus according to claim 1, further comprising a display mode changing device which changes visual display condition of that area of the display screen which corresponds to the input member before and after the detection by the coordinate position detecting device.

3. The input apparatus according to claim 2, wherein the display mode changing device displays the area corresponding to the input member in a display mode different from that before the detection while the coordinate position detecting device is detecting the coordinate position of the displacement of the specific region on the display screen.

4. The input apparatus according to claim 3, wherein the display mode changing device displays the area corresponding to the input member in a display mode different from that before the detection at least for a certain period after the coordinate position detecting device starts detecting the coordinate position of the displacement of the specific,region on the display screen.

5. The input apparatus according to claim 2, wherein the input member comprises a push pad embossed to represent characters and symbols and a projection located at the tip and bent toward the display screen.

6. The input apparatus according to claim 2, wherein the input member includes a button holder which extends in a horizontal direction and has a dish-shaped depression near a tip of the button holder with an opening provided in the dish-shaped depression; and a push button which is loosely fitted in the opening in a vertically movable manner and urged by a spring in a direction away from the display screen.

7. The input apparatus according to claim 2, wherein the coordinate position detecting device detects the coordinate position of a displaced spot of the specific region by being brought by the displacement of the specific region of the input member into direct contact with the specific region.

8. The input apparatus according to claim 2, wherein the coordinate position detecting device detects the coordinate position of a displaced spot based on presence or absence of a beam caused by the displacement of the specific region.

9. The input apparatus according to claim 2, wherein the coordinate position detecting device detects the coordinate position of a displaced spot by analyzing images of the displacement of the specific region.

10. The input apparatus according to claim 2, wherein the coordinate position detecting device detects the coordinate position of a displaced spot by analyzing ultrasonic waves affected by the displacement of the specific region.

11. The input apparatus according to claim 2, wherein the transparent material forms a convex lens which magnifies an appropriate region of the display screen.

12. A touch-reading character/symbol input method comprising:
(a) detecting displacement of a specific region of an input member which is made of a transparent member to allow at least part of beams to pass and placed in a region of space in front of the display screen which visually displays information and elastically displaces the specific region toward the display screen in response to an external force, where embosses are formed on a surface of the input member to represent at least one of characters and symbols; and
(b) inputting at least the one of characters and symbols represented by the embosses on the transparent member by detecting, on the display screen, coordinates of any displacement detected in the step (a).

13. The touch-reading character/symbol input method according to claim 12, further comprising:
(c) changing visual display mode of that region of the display screen which corresponds to the displaced transparent member when displacement is detected in the step (a).

14. The touch-reading character/symbol input method according to claim 13, wherein the coordinates on the display screen are detected by detecting the coordinate position of a displaced spot based on presence or absence of a beam caused by the displacement of the specific region.

15. The touch-reading character/symbol input method according to claim 13, wherein the coordinate position on the display screen is detected as the coordinate position detecting device is brought by the displacement of the specific region of the input member into direct contact with the specific region.
